(19) United States
(12) Patent Application Publication
(10) Pub. No.: US 2002/0181435 A1
(43) Pub. Date: Dec. 5, 2002

(54) Communications systems

(76) Inventors: Gyorgy Miklos, Budapest (HU); Zoltan Turanyi, Budapest (HU); Ferenc Kubinszky, Szentendre (HU); Andras Valko, Budapest (HU); Andras Racz, Budapest (HU)

Correspondence Address: Stanley R. Moore, Esq., Jenkens and Gilchrist, P.C., 3200 Fountain Place, 1445 Ross Ave., Dallas, TX, 75202, US

(21) Appl. No.: 10/128,448

(22) Filed: Apr. 23, 2002

(30) Foreign Application Priority Data
Apr. 27, 2001 (GB) 0110399.3

(51) Int. Cl. H04B 7/212

(52) U.S. Cl. 370/348; 370/445

(57) ABSTRACT

In a wireless communications network, communication between a source node and a destination node is initiated following detection of a free channel, using a request and acknowledgement exchange. If the exchange fails, a request retry is performed after a randomly determined time period.

The present invention relates to wireless communications systems.

### BACKGROUND OF THE INVENTION

The present invention concerns the short range radio-frequency protocols, such as that known as Bluetooth. Specifically, embodiments of the invention address the question of how a data transmission is initiated. The solution concerns both intra- and inter-piconet communication.

The current Bluetooth specification 1.1 uses dedicated master node to slave node and slave node to master node timeslots in a channel (or piconet). Scheduling within a piconet is performed at the master node. Slave to master communication is made possible by the use of polling: the master node polls the slaves to determine whether or not a slave node has data to transmit. Inter-piconet communication is not specified in the Bluetooth specification at all. Nodes have to use a dedicated algorithm, which could include signalling, to switch between the piconets making inter-piconet scheduling complex and making communication very inefficient.

In data communications in a Bluetooth system, it is difficult to know how to set the parameters in the scheduling/polling algorithm in the case of intra-piconet communication. A bad parameter setting can have a serious negative effect, and the scheduling/polling algorithm presents added complexity. In the case of inter-piconet communication, a dedicated scheduling algorithm may give a very high overhead, and is difficult to satisfy data applications which cannot well predict their traffic in advance.

### SUMMARY OF THE PRESENT INVENTION

In accordance with one aspect of the present invention, a solution is proposed where nodes use random access for intra- and inter-piconet communications.

Within a piconet, the present solution uses random access to support best effort data traffic. A contention resolution mechanism is introduced. A node that has a data packet or frame to send first waits until the piconet becomes free. Then it sends an RTS (ready to send) packet to the destination. If the destination responds with a CTS (clear to send) in the next slot, data transmission may follow. If no valid CTS is received, the node goes to a back-off state and re-transmits the RTS after a random amount of time.

For inter-piconet communication, the present invention uses random access similarly as in the case of intra-piconet communication. In addition, selection of frequency hopping sequence for each data packet is allowed.

Note that although the present invention is described in terms of Bluetooth technology, it may be applicable to other radio technologies as well, and specifically it may be applicable to other systems using frequency hopping radio technology.

### DETAILED DESCRIPTION OF THE PREFERRED EMBODIMENT

### Intra-piconet Data Transfer

Embodiments of the present invention use random access communication within a piconet. Data transmission is always initiated, by an RTS request (request to send)/CTS (clear to send) message exchange, as in the IEEE 802.11 wireless LAN protocol. For example, a successful RTS-CTS message exchange is followed by the transmission of a full upper-layer packet. These are typically IP packets, but for generality upper-layer packets are referred to as frames in the present description. Frames are segmented to form and reassembled from baseband packets occupying from one to five timeslots.

Initiation of data packet transmission in accordance with an aspect of the present invention includes the following steps:

Waiting until the piconet is sensed to be free;

Sending an RTS packet to the destination node;

Waiting for the reception of a returning CTS packet;

If the CTS packet does not arrive, retransmitting the RTS using a random backoff period while listening to the piconet channel;

If there is no CTS response for the retransmission of the RTS for a specified threshold, re-synchronise to the node and if the destination node is present, the procedure is continued with the re-transmission of the RTS.

If the CTS arrives, continue with the data transfer.

The transmitter node that has a frame to send first waits until any current data transfer in the piconet is finished. The transmitter node then sends an RTS packet to the receiver node using the frequency hopping sequence of the piconet concerned. In the next timeslot, the transmitter node switches on its receiver in preparation to receive any CTS response. If a valid CTS is received that acknowledges the RTS, then the transmitter may proceed with its data packet in the following timeslot. If there is no valid CTS response, then the transmitter node goes to an exponential backoff wait period and resents its RTS packet at a later, randomly chosen slot. During this backoff period, the transmitter node continues to receive packets. If a packet addressed to a different node is received then the transmitter node waits until the new data transfer in the piconet is over and continues the contention afterwards. If it receives an RTS packet addressed to it, then it responds with a CTS, so that the node is ready to receive a frame even during a backoff period. If there is no CTS response for the retransmission of the RTS for a specified threshold, the destination nodes presence is checked in a re-synchronisation procedure and if the node is found, the RTS is re-transmitted and the procedure continues.

### Waiting Until the Piconet is Sensed Free

According to embodiments of the present invention, a node has to wait until the piconet is sensed free to initiate the transmission of a new frame by sending an RTS. The piconet is sensed free by a node if it has received an acknowledge packet acknowledging last data segment of a frame and no packets afterwards, or when it has not sensed any transmission in the piconet for six consecutive slots.

The motivation for requiring a node to wait for six consecutive slots is that Bluetooth baseband packets are from one to five timeslots in length, and they are always transmitted on a single frequency. This means that in five consecutive slots, at least one new packet has to be sent if there is to be ongoing data transmission. This can be detected by other nodes on the frequency defined by the piconet's frequency hopping sequence. Each data packet is followed by an acknowledgement packet that is only a single slot length by default. It follows that either the source or destination can be detected in six consecutive slots, depending on whether they are within the transmission range.

Note that this parameter (the number of slots the piconet has to be sensed free before an RTS can be send) is recommended to be set to the maximum length of a data packet plus maximum length of acknowledgement packet in case the default baseband packet length values are changed. Alternatively, it is possible to set this parameter to a different value to make the detection of when the piconet is sensed free more conservative or less conservative. It will be readily appreciated that the number of timeslots defined for determining whether the piconet is free or not can be arbitrarily chosen in dependence upon the application and/or communications protocol being used.

As an example of the application of the above rule, consider a node that hears an RTS but no CTS afterwards. It has to wait for six consecutive slots before it sends an RTS. This is useful in the case where S, T are slaves and M is the master. M sends an RTS to S which is heard by T, but T does not hear the CTS response from S. If the data transmission between M and S starts, T refrains from sending an RTS until the data transmission is over, even though it did not hear the CTS from S.

### Sending the RTS and CTS Packets

Once the transmitter node has waited until the piconet becomes free, it sends the RTS (ready to send) packet. The receiver node, upon receiving a single RTS packet correctly, responds with a CTS (clear to send) packet preferably in the next timeslot.

Alternatively, it is possible to implement the protocol in such a way that the CTS packet is sent not in the next timeslot, but in the second, third etc. consecutive timeslots thereafter. In this case the transmitter and receiver nodes ignore the intermediate timeslots between the RTS and CTS. The advantage of this alternative is that this makes it possible to incorporate slow devices where the protocol is implemented in software. The disadvantage is that this takes higher overheads, and it increases the probability that two pairs of nodes engage in simultaneous data transfers that interfere. In the following examples, the first example will be used; ie. the CTS is sent in the next timeslot immediately after the RTS.

The following tables show the format of the RTS and CTS packets.

The RTS message contains the following fields:

Message type
Source address
Destination address
Frame length
Piconet selection information

The CTS message contains the following fields:

Message type
Source address
Destination address
Frame length
Piconet selection information

Both the RTS and CTS packets include a message type field that indicates the type of packet. They both contain the source and destination addresses of the packet using the MAC address of the transmitter and receiver nodes. The RTS packet contains the length of the frame in bytes, which is echoed in the CTS packet. It is used by the destination later on to determine when the reception of the current frame is over. (The length field can also be used by other nodes to estimate the time length of the data transfer).

Besides the above fields, the RTS and CTS packets contain information that is needed for the negotiation of the piconet to be selected for the data transfer, and information that is needed to switch to the selected piconet. This is described in more detail below.

Once the RTS is sent, the node waits for a CTS in the next slot. If it does not arrive, the node retransmits the RTS using a backoff procedure, as described below.

### Retransmit RTS with Backoff

The backoff procedure works as follows. Every source (transmitter node) has a variable BC (backoff counter). A positive value of BC is decreased at the end of each timeslot when the destination (receiver node) is believed to listen to potential RTS packets (see below) and the piconet is sensed free (as defined above). The RTS packet may be sent when the value of BC reaches zero.

The destination is believed to listen to potential RTS packets when it is not sleeping (ie. When it is not in a power saving state in the given timeslot, see below), and when it is not performing a previously announced action such as scanning or sending a beacon packet or reserving the slot for QoS traffic support (SCO link or a different type of reservation, see below).

The value of BC is reset after a successful or unsuccessful RTS-CTS message exchange to a random value chosen uniformly from the interval (0,CV), where CV is the contention window and O is included, CV not included in the interval. After a successful RTS-CTS exchange, the value of CV is set to CVmin (a constant). After an unsuccessful RTS-CTS exchange (that is, a CTS did not arrive in response to the RTS packet), the value of CV is doubled. If its value exceeds the ceiling CVmax, then it is set to CVmax (another constant).

Possible values for the constants are CVmin=2, CVmax=256.

This is the procedure that determines how to set the backoff counter BC, and this shows when the RTS can be sent or resent.

According to the above procedure, the RTS could be resent again and again. However, in a preferred embodiment of the present invention an upper limit is imposed on the number of RTS retransmission attempts as described below.

In the procedure that follows, we assume that there exists a re-synchronisation procedure by which the presence of a neighbour can be verified and its state information updated. This re-synchronisation procedure can be based on signalling packets. (If such a procedure is not available, then instead of re-synchronisation it is assumed that the destination is currently not reachable and abort the current packet transmission.)

Retransmit the RTS packet according to the procedure above a maximum of RTHRS1 amount of times.

When the RTS transmission is still unsuccessful, perform a re-synchronisation procedure.

When it is not possible to re-synchronise to the destination, then the destination is considered to be currently unreachable and sending of the current packet is aborted.

When it is possible to successfully re-synchronise to the destination, update the status information stored about the destination.

Retransmit the RTS packet again, a maximum of RTHRS2 amount of times.

If it is still unsuccessful, then the destination is considered to be currently unreachable and sending of the current packet is aborted.

Possible values for the constants are RTHRS1=5, RTHRS2=15.

Note that the above procedure can be modified in many ways: for example, the limit for the retransmissions may be given in time units instead of maximising the number of retransmissions. Another possibility for modification is to perform the re-synchronisation parallel to the retransmission of RTS packets.

Note also that the value of the backoff counter BV and the value of the contention window CV are not modified during the re-synchronisation procedure.

### Data Transfer

Once the source has sent the RTS and has received a CTS response to it in the next timeslot, it continues with the actual data transfer in the following timeslot.

A frame is segmented to baseband packets of length of one to five timeslots. The data transmission means sending the baseband packets to the destination and listening for acknowledgement packets in the next timeslot. The acknowledgement packets are single slot baseband packets by default. Preferably, a single-bit acknowledgement is used: this shows whether the last packet was received correctly or not. The source works as follows: it retransmits the last baseband packet if the acknowledgement is negative or if the acknowledgement packet is not received correctly. Otherwise it continues with the next baseband packet segment of the frame (if one exists).

The number of allowed retransmissions for a single baseband packet is limited (RTHRS, a constant, eg. 8). If the retransmission is still unacknowledged and the limit is reached, then the transmission of the current frame is aborted. This avoids the deadlock that would otherwise occur when a link is broken.

Each data and acknowledgement baseband packet carries an access code in its header that is derived from the piconet's master address (which identifies the piconet). In addition, each data and acknowledgement packet carries with it a transmission ID that is derived from the source and destination addresses. The access code is used to confirm that the piconet where a given packet is sent is the same piconet on which the destination is listening. The transmission ID is used to confirm that the given packet is from the intended source, and not sent by another node in the piconet. The advantage of using the transmission ID instead of the source and destination MAC addresses is that it can be much shorter in length, reducing the overhead per baseband packet.

Besides the frame length field in the RTS and CTS packets, other methods can be used in order to estimate the length of the currently transmitted frame. Using a field in the header of data and acknowledgement packets giving the amount of remaining data in the transmission of the current frame in bytes is one possibility. Using such a field, all nodes in the piconet receiving a data or acknowledgement packet become aware of the remaining length of the transmission of the current frame and can estimate when the data transfer ends. (This is only an estimation since the number of necessary retransmissions cannot be determined in advance). The usefulness of the estimation is that these nodes can switch themselves off and save power until the transmission ends.

A simplified alternative of the above scheme is to use, instead of the amount of remaining bytes, only a one-bit indicator which indicates the last baseband packet segment of a frame. This is not suitable for estimating the length of the frame, but it is sufficient to indicate when the transmission of the frame ends. (Without this information, the present invention may still be applied, but then nodes will not be able to determine the last ack packet of a frame, and they have to wait for six consecutive empty slots to confirm that the transmission of the current frame is over).

A number of different coding schemes and baseband packet lengths (typically one to five) can be used for the transmission of a baseband packet. They differ in the amount of protection they provide against transmission errors and the amount of overhead they impose due to redundancy (FEC). The source of data packets can determine which packet type to use for the transmission of a given frame. This also determines the number of baseband packets into which a given frame is segmented.

In a preferred embodiment the same packet type (coding and baseband packet length) is used within a frame. This not only makes segmentation and reassembly easier (since the number of possible user data bits are the same in each baseband packet) but also makes it much more predictable for nodes other than the source and destination to determine how many slots the transmission of a given frame lasts. This is true because they only need to determine the packet type and the number of bytes in the frame once to determine the number of slots the transmission will take (without the retransmissions). Alternatively, it is also possible to adapt the packet type during the transmission of a frame, but then the advantages mentioned above are not realised.

### Slave to Slave Communication

In an embodiment of the present invention, it is possible for a slave node to communicate directly with another slave node in the same piconet. This is made possible by the RTS-CTS message exchange because these packets contain the MAC address of the source and destination. Note that the relatively long MAC addresses are only present in the RTS and CTS packets and not in the data packets. In the header of the data packets, only a short transfer is used.

In addition to solving the addressing problem, the RTS-CTS message exchange also decreases the effect of the well-known hidden terminal problem, as in the 802.11 WLAN protocol.

The possibility for slave to slave communication makes communication between nodes much more flexible. The master is used only to define the piconet's frequency hopping sequence, but it does not influence which node is allowed to communicate with a certain other node.

Note that it is possible to implement the present invention in an alternative way where the slave nodes are limited to communicate with a master node (slave to slave communication is forbidden). Although this alternative does not possess the advantages mentioned above, it might be advantageous from a different aspect: it avoids the so-called capture effect.

The capture effect means that a communicating device has higher changes to win the contention for the next transfer. This is illustrated in the following example. Suppose S communicates with T (S,T are slaves). U is another slave that wishes to communicate with the master M. M can hear the data transfer between S and T, but U cannot. Therefore, U senses the channel to be free and sends an RTS to M. However, this transmission collides at M with the data transmission between S and T and therefore M cannot decode it. It follows that the RTS, as well as its retransmissions, are not answered by M. U backs off, without knowing when the frame transmissions between S and T end. S, T and M have much higher changes to continue with the next frame because they are aware of when the transmission of the current frame ends, and they can immediately send an RTS afterwards. However, U does not know when the transmission of a frame ends between S and T, and so it may be forced to starve until the communication between S and T finishes.

This problem does not arise when only master-slave communication is allowed and not slave-slave communication This is because all slaves can hear either the data or ack packets of the master in the ongoing data transfer and from this, they can estimate when the transmission of the current frame ends.

### Inter-piconet Data Transfer

A node initiates the transmission of a frame to a destination node in a different piconet in the same way as it initiates a data transfer in its own piconet. That is, it begins by waiting until the destination node's piconet is sensed free. This is done by following the same rule as described above: the piconet is sensed free if it has received an ack packet acknowledging the last data segment of a frame and no packets afterwards, or when it has not sensed any transmission in the piconet for six consecutive slots.

Note that this requires the knowledge of the frequency hopping sequence used in the destination node's piconet, as well as the possibility to leave the source node's current piconet.

When the destination node's piconet is sensed free, the node sends an RTS packet to the destination node and in the next slot switches on its receiver to receiver the CTS response. If a valid CTS response can be decoded, the node proceeds with the data transfer in the same way as in the case of intra-piconet communication. If no valid CTS response can be decoded, then the node performs a backoff in the same way as in the case of intra-piconet communication. For the duration of the backoff, however, the node returns to its own piconet's frequency hopping sequence until it resends the RTS. Thereby the node is available for other neighbouring nodes to access it by an RTS.

After the RTS-CTS message exchange is completed, data transfer takes place using the frequency hopping sequence selected in the RTS-CTS packets as described below.

### Selection of Piconet: General Approach

In a successful RTS-CTS message exchange, the source and destination nodes negotiate which piconet to use for the data transfer.

The source and destination can choose from a total of four different piconets (out of which some may be identical). These are: the frequency hopping sequence defined by the clock and address of the source node, referred to as device piconet of the source node; the currently used piconet of the source node, referred to as the home piconet of the source node; and similarly the device piconet of the destination node and the home piconet of the destination node.

As a general approach, it is suggested that the negotiation of the piconet used for the data transfer takes place as follows. The source signals its preferences and capabilities in the ‘piconet selection’ field of the RTS. In the CTS response, the destination signals its choice based on the source's capabilities and preferences and according to its own capabilities and preferences. If the choice is different from the destination's home piconet (where the RTS-CTS message exchange takes place), then the nodes switch to the new piconet and repeat the RTS-CTS message exchange. If this is successful, then they continue with the data transfer. When the RTS-CTS message exchange is not successful or when the nodes finish the transmission of the frame, the nodes return to their original home piconets.

There are a large number of possibilities for how the piconet selection can be implemented according to the general approach described above.

As a first alternative, the source sends in its RTS, a four-bit piconet capabilities field that shows which of the four possible piconets the node is ready to send the frame. The destination node chooses one of the allowed piconets according to its own capabilities and preferences. (For example, it has a priority list of the four piconets: its home piconet, its device piconet, the source's device piconet, the source's home piconet). The destination chooses the first one in the list that is allowed by the source.

Note that in order to choose a given piconet, both the source and destination must have up-to-date information about the given piconet's frequency hopping sequence, namely the master's address and clock. For this reason, the RTS packet may contain information about the source node's clock, its master address and clock. The CTS packet may contain information about its clock. (The destination node's master and clock is assumed to be known by the source since the destination node's home piconet is where it initiated the transfer).

Additionally, the RTS packet may contain preferences about certain piconets. Alternatively, nodes may transmit their preferences not in the RTS packet, but in signalling packets.

### Power Saving

If it is allowed to send an RTS to a node in any timeslot, then it follows that nodes must switch on their receivers in every timeslot. This consumes some power, especially because the receive window at the beginning of a slot must be long enough to accommodate some clock inaccuracy. This motivates the need for power saving modes when a node does not need to switch on its receiver in every timeslot.

A node itself may decide to go to a power saving mode with a receive period of T_{R}. This means that it has only one timeslot in a time period of T_{R} when it is ready to receive an RTS packet. In the rest of the timeslots it can switch its receiver off completely to save power (but note that the signalling packets may still be needed). The value of T_{R} is advertised in the signalling packets so that every neighbour is aware of the receive period.

The receive timeslot within the receive period is designated in such a way that the knowledge of T_{R}, the source address of the node and the clock of the home piconet is sufficient to determine them. One possibility is the following: the value of T_{R} is always a power of two number of timeslots. The receive slot is the one where the last bits of the home piconet clock are identical to the source address of the node. This is easy to compute in advance, and distributes the receive timeslots of different nodes in a pseudo-random way.

A node may implement any algorithm to determine the value of T_{R}. The algorithm should be such, however, that it does not change this parameter very quickly, since that would be hard to follow by the other nodes.

One straightforward implementation would be to designate an ACTIVE and an INACTIVE MODE. In ACTIVE mode, the value of T_{R} is set to T_{R, active} (for example, Tₛ meaning that the node is ready to receive an RTS in every timeslot). In INACTIVE mode, the value of T_{R} is set to T_{R}, inactive (for example, 1024 Tₛ meaning that there is only one receive timeslot in 0.64 sec). A node changes to INACTIVE mode when there is no traffic for a given amount of time; when the node sends or receives some data, it switches to ACTIVE mode.

The backoff counter is then decreased and an RTS can be sent only when the destination is ready to receive an RTS packet, and freezed in the timeslots when the destination does not switch on its receiver due to power save, as mentioned above.

### QoS Reservations

In order to support QoS (Quality of Service) requirements, a node may reserve some of its timeslots. This can be incorporated into a method embodying the present invention as follows.

Nodes negotiate reservations using an upper-layer protocol, eg. RSVP-IETS RFC No. 2205. The reservations are translated into timeslot reservations. This means that in a period Tᵣₑₛ, an integer number of consecutive timeslots, Nᵣₑₛ are reserved, starting at time Tₛₜₐᵣₜ. (This is a generalisation of the SCO scheme of the Bluetooth specification 1.1, where two out of six slots are reserved for a single SCO connection.)

The reservations are advertised to the neighbours giving the parameters Tᵣₑₛ, Nᵣₑₛ, Tₛₜₐᵣₜ. In this way neighbours become aware of which timeslots are reserved.

Similarly to power saving method described above, an RTS packet is not sent and the backoff counter is not decreased in the timeslots that are reserved for QoS traffic.

### Bi-directional Data Transfer

It is possible to make better utilisation of the acknowledgement (ack) packets by attaching data to them. In this optional improvement, a destination that has data to send to the source may attach its data to the ack packets.

Note that this is an improvement only, and this alternative does not change the basic scheme of data transmission. Specifically, the number of remaining bytes from the current frame as it appears in the packet headers reflects the status of the forward direction from the source to the destination. Also, when the transmission of the frame ends in the forward direction, the data transfer cannot be continued in the reverse direction. For this, a new RTS-CTS message exchange has to take place.

Alternatively, it is possible to use not only single-timeslot packets, but, for example, one to five timeslot packets in the reverse (destination to source) direction. This can better support reverse direction traffic. However, in this case the condition for sensing the piconet free has to be changed: a node has to wait for ten (rather than six) consecutive slots with no traffic.

### Broadcast

So far, methods embodying the invention have been discussed with reference to unicast traffic only. However, there is a possibility to send broadcast packets in a piconet as well, and a broadcast method embodying the invention is described below.

A broadcast frame is initiated with an RTS-CTS message exchange. This is useful because in this case there is no priority difference between unicast and broadcast packets. (The alternative is to send broadcast packets without the RTS-CTS message exchange, but in that case broadcast traffic would starve unicast traffic).

A special ‘broadcast bit’ in the RTS and CTS messages signal that the frame is intended as a broadcast frame. The RTS is addressed to a specific neighbour node that the sender node believes to be present. The node addressed in the RTS is the one that has to respond to the RTS by a CTS. A slave node may choose to send the RTS to the master, while the master can choose, for example, the slave with which it last communicated.

Once the RTS-CTS message exchange has been completed, all nodes that could receive the RTS (including those that could receive the RTS but not the CTS) continue to listen to incoming packets. There is a significant difference compared to the unicast data transfer: broadcast frames are not acknowledged. According to one possibility, the source sends the Bluetooth baseband packets one after the other until the complete frame is transmitted, without waiting for the acknowledgement packets from the receiver.

As an alternative to the broadcast technique described above, it is possible to provide an emulated broadcast as follows. A frame that is intended for broadcast is sent by the normal unicast transmission mechanism to all known neighbours of the node. The disadvantage of this approach is that it consumes much more capacity, and it can be sent to all known neighbours only (the previous procedure could be received by neighbours that are not known by the node). The advantage is that this method of emulated broadcast is reliable, since unicast transmissions must be acknowledged by the receiver.

### No RTS/CTS

It is possible to apply the methodology of the present invention in a different context without the RTS/CTS message exchange, provided that the addressing of nodes can be solved in a suitable manner. For example, the sending of data packets can make use of the back off scheme described above. When the channel is sensed to be free, a data packet is sent. If no acknowledgement packet is received, then the data packet is retransmitted following an appropriate back off period, as described above with reference to RTS packets. In such a case the first data packet can be understood to be a requesting packet.

1. A method of initiating data transfer between a source node and a destination node in a wireless communications system, the method comprising, in the source node:
monitoring use of an initial communication channel, and if the initial communication channel is unused:
transmitting a request signal on the initial communication channel to the destination node, which request signal includes information identifying a source-preferred data communication channel;
scanning for an acknowledgement signal from the destination node on the initial communication channel, which acknowledgement signal includes information identifying a destination-preferred data communication channel; and
if an acknowledgement signal is received from the destination node:
defining a selected data communication channel on the basis of information included in the request and acknowledgement signals; and
initiating data transfer with the destination node on the selected data communication channel; or
if an acknowledgement signal is not received from the destination node, retransmitting the request signal after a randomly selected time period.

2. A method as claimed in claim 1, wherein the time period is randomly selected from a predetermined range of time period values.

3. A method as claimed in claim 1 or 2, wherein the channel is a frequency hopping channel.

4. A method as claimed in claim 1, 2 or 3, wherein the channel is sensed to be free if no signal is detected on the channel for a predetermined time period.

5. A method as claimed in claim 4, wherein the predetermined time period is defined by a predetermined number of timeslots.

6. A method as claimed in claim 5, wherein the predetermined number of timeslots is six.

7. A method as claimed in any one of the preceding claims, wherein retransmission of the request signal is attempted for a predetermined maximum number of times.

8. A method as claimed in claim 7, wherein following the predetermined maximum number of retries of sending the request signal, the node is resynchronised to the channel.

9. A method as claimed in any one of the preceding claims, wherein defining the selected data communication channel comprises selecting the channel on the basis of the transmission and reception capabilities of the source node.

10. A method as claimed in any one of claims 1 to 9, wherein defining the selected data communication channel comprises selecting the channel on the basis of the transmission and reception capabilities of the destination node.

11. A method as claimed in any one of the preceding claims, wherein the request signal includes information indicative of the transmission and reception capabilities of the source node.

12. A method as claimed in any one of the preceding claims, wherein the acknowledgement signal includes information indicative of the transmission and reception capabilities of the destination node.

13. A method as claimed in any one of the preceding claims, wherein the wireless communications system is a short-range packet based communications system

14. A method as claimed in any one of the preceding claims, wherein nodes of the system have active and inactive periods of operation, and the request signal is transmitted to the destination node only during an active period of operation thereof.

15. A method as claimed in any one of the preceding claims, wherein the initial communication channel is selected with reference to the destination node.

16. A method as claimed in any one of the preceding claims, wherein nodes of the system can reserve time periods, and the request signal is transmitted to the destination only in unreserved time periods thereof.

17. A method of initiating data transfer in a wireless communication system, the method comprising, in a node of the system:
transmitting a request signal to a proposed destination node of the system;
scanning for an acknowledgement signal from the proposed destination node; and
if an acknowledgement signal is received from the proposed destination node, initiating data transfer with the destination node; or
if no acknowledgement signal is received from the proposed destination node, retransmitting the request signal after a time period determined by a counter.

18. A method as claimed in claim 6, wherein the counter is reset to a random value chosen from a predetermined interval, following successful receipt of an acknowledgement signal.
